(19) United States
(12) Patent Application Publication
(10) Pub. No.: US 2020/0051430 A1
(43) Pub. Date: Feb. 13, 2020

(54) SYSTEM AND METHOD TO GENERATE RECOMMENDATIONS FOR TRAFFIC MANAGEMENT

(71) Applicant: HCL TECHNOLOGIES LIMITED, Noida (IN)

(72) Inventors: Gaurav VRATI, Noida (IN); Sanjay YADAV, Noida (IN)

(21) Appl. No.: 16/058,838

(22) Filed: Aug. 8, 2018

(51) Int. Cl. G08G 1/01; G01C 21/34

(52) U.S. Cl. CPC G08G 1/0145; G01C 21/3415; G08G 1/0129

(57) ABSTRACT

The present disclosure relates to system(s) and method(s) to generate recommendations for traffic management. The system receives historical traffic data associated with each road segment in a target geographical location. Further, the system analyses the historical traffic data to forecast a traffic intensity corresponding to each road segment. The system compares the traffic intensity with a predefined threshold upper value to identify one or more congested road segments. The system further compares the traffic intensity with a predefined threshold lower value to identify one or more uncrowded road segments, when the threshold intensity is less than the predefined threshold upper value. The system identifies a target road segment, from the one or more uncrowded road segments, corresponding to each congested road segment using a routing algorithm. The system further generates one or more recommendations based on the target road segment for traffic management.

### CROSS-REFERENCE TO RELATED APPLICATIONS AND PRIORITY

The present application does not claim priority from any patent application.

### TECHNICAL FIELD

The present disclosure in general relates to the field of generating recommendations. More particularly, the present invention relates to a system and method to generate recommendations for traffic management.

### BACKGROUND

Nowadays, with increase in population and growth in economy, there is constant demand for both commercial and domestic vehicles. However, due to high number of vehicles on a road, people faces a lot of traffic issues such as, high traffic congestion level, increase in road accidents, rise in fuel consumption, long travel hours, increase in pollution level due to vehicle emissions and the like. In this case, one of the solution to resolve these traffic issues is infrastructure development and modernization i.e. constructing new roads, flyovers, underpass roads etc. However, it requires a lot of time for planning infrastructure development and modernization. Thus, there is need to optimally utilize the available resources such as roads and traffic signals for traffic management. Currently, there is no technology available that provides suggestions for utilizing the available resources.

### SUMMARY

Before the present systems and methods to generate recommendations for traffic management, is described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods to generate recommendations for traffic management. This summary is not intended to identify essential features of the claimed subject matter nor is it intended for use in determining or limiting the scope of the claimed subject matter.

In one implementation, a system to generate recommendations for traffic management is illustrated. The system comprises a memory and a processor coupled to the memory, further the processor is configured to execute programmed instructions stored in the memory. In one embodiment, the processor may execute programmed instructions stored in the memory for receiving historical traffic data, associated with a target geographical location, from a set of sources. The historical traffic data comprises traffic data corresponding to each road segment, from a set of road segments, in the target geographical location. Further, the processor may execute programmed instructions stored in the memory for analysing the traffic data, corresponding to each road segment, using at least one machine learning algorithm, from a set of machine learning algorithms, to forecast a traffic intensity, corresponding to each road segment, at pre-defined day parameter. Furthermore, the processor may execute programmed instructions stored in the memory for comparing the traffic intensity, corresponding to each road segment, with a predefined upper threshold value to identify one or more congested road segments from the set of road segments. The processor may execute programmed instructions stored in the memory for comparing the traffic intensity, corresponding to each road segment, with a predefined lower threshold value to identify one or more uncrowded road segments from the set of road segments, when the traffic intensity is less than the predefined upper threshold value. The processor may execute programmed instructions stored in the memory for identifying a target road segment, from the one or more uncrowded road segments, corresponding to each congested road segment using at least one routing algorithm from a set of routing algorithms. Further, the processor may execute programmed instructions stored in the memory for generating one or more recommendations corresponding the one or more congested road segments and the one or more uncrowded road segments for traffic management.

In another implementation, a method to generate recommendations for traffic management is illustrated. In one embodiment, the method may comprise receiving historical traffic data, associated with a target geographical location, from a set of sources. The historical traffic data comprises traffic data corresponding to each road segment, from a set of road segments, in the target geographical location. Further, the method may comprise analysing the traffic data, corresponding to each road segment, using at least one machine learning algorithm, from a set of machine learning algorithms, to forecast a traffic intensity corresponding to each road segment at pre-defined day parameter. Furthermore, the method may comprise comparing the traffic intensity, corresponding to each road segment, with a predefined upper threshold value to identify one or more congested road segments from the set of road segments. The method may comprise comparing the traffic intensity, corresponding to each road segment, with a predefined lower threshold value to identify one or more uncrowded road segments from the set of road segments, when the traffic intensity is less than the predefined upper threshold value. The method may further comprise identifying a target road segment, from the one or more uncrowded road segments, corresponding to each congested road segment using at least one routing algorithm from a set of routing algorithms. Further, the method may comprise generating one or more recommendations corresponding the one or more congested road segments and the one or more uncrowded road segments for traffic management.

In yet another implementation, a computer program product having embodied computer program to generate recommendations for traffic management is disclosed. In one embodiment, the program may comprise a program code for receiving historical traffic data, associated with a target geographical location, from a set of sources. The historical traffic data comprises traffic data corresponding to each road segment, from a set of road segments, in the target geographical location. Further, the program may comprise a program code for analysing the traffic data, corresponding to each road segment, using at least one machine learning algorithm, from a set of machine learning algorithms, to forecast a traffic intensity corresponding to each road segment at pre-defined day parameter. Furthermore, the program may comprise a program code for comparing the traffic intensity, corresponding to each road segment, with a predefined upper threshold value to identify one or more congested road segments from the set of road segments. The program may comprise a program code for comparing the traffic intensity, corresponding to each road segment, with a predefined lower threshold value to identify one or more uncrowded road segments from the set of road segments, when the traffic intensity is less than the predefined upper threshold value. The program may further comprise a program code for identifying a target road segment, from the one or more uncrowded road segments, corresponding to each congested road segment using at least one routing algorithm from a set of routing algorithms. Further, the program may comprise a program code for generating one or more recommendations corresponding the one or more congested road segments and the one or more uncrowded road segments for traffic management.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system to generate recommendations for traffic management, in accordance with an embodiment of the present subject matter.

FIG. 2 illustrates the system to generate recommendations for traffic management, m accordance with an embodiment of the present subject matter.

FIG. 3 illustrates a method to generate recommendations for traffic management, in accordance with an embodiment of the present subject matter.

FIGS. 4, 5 and 6 illustrates an exemplary embodiment of the system generating recommendations for traffic management, in accordance with an embodiment of the present subject matter.

FIG. 7 illustrates pre-processing of historical traffic data, in accordance with an embodiment of the present subject matter.

FIG. 8 illustrates analysis of the historical traffic data using machine learning algorithm, in accordance with an embodiment of the present subject matter.

FIG. 9 illustrates identification of target road segment using routing algorithm, in accordance with an embodiment of the present subject matter.

### DETAILED DESCRIPTION

Some embodiments of the present disclosure, illustrating all its features, will now be discussed in detail. The words “receiving”, “analysing”, “comparing”, “identifying”, “generating” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in the practice or testing of embodiments of the present disclosure, the exemplary, systems and methods to generate recommendations for traffic management are now described. The disclosed embodiments of the system and method to generate recommendations for traffic management are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure to generate recommendations for traffic management is not intended to be limited to the embodiments illustrated, but is to be accorded the widest scope consistent with the principles and features described herein.

The present subject matter relates to generating recommendations for traffic management. In one embodiment, historical traffic data, associated with a target geographical location, may be received. The historical traffic data may be received from third-party data providers, government agencies and the like. The historical traffic data may correspond to traffic data corresponding to each road segment, from a set of road segments, in the target geographical location. The historical traffic data may correspond to vehicle speeds, traffic accidental incidences, vehicle types, vehicle count, pollution level, weather conditions, festival/seasonal effect, pedestrian count and the like. Once the historical traffic data is received, the historical traffic data may be analysed using at least one machine learning algorithm, from a set of machine learning algorithms. The set of machine learning algorithms may comprise a Convolutional Neural Network, a Deep Neural Network, and a Recurrent Neural Network. Further, a traffic intensity, corresponding to each road segment, may be determined based on the analysis of historical traffic data at pre-defined day parameters. Further, the traffic intensity may be compared with a predefined upper threshold value to identify one or more congested road segments. The traffic intensity may be compared with a predefined lower threshold value to identify one or more uncrowded road segments, when the traffic intensity is less than the predefined upper threshold value. Further, a target road segment, from the one or more uncrowded road segments, corresponding to each congested road segment using at least one routing algorithm, from a set of routing algorithms. Further, one or more recommendations may be generated based on the target road segment for traffic management. The one or more recommendations may be associated with the one or more congested road segments and the one or more uncrowded road segments.

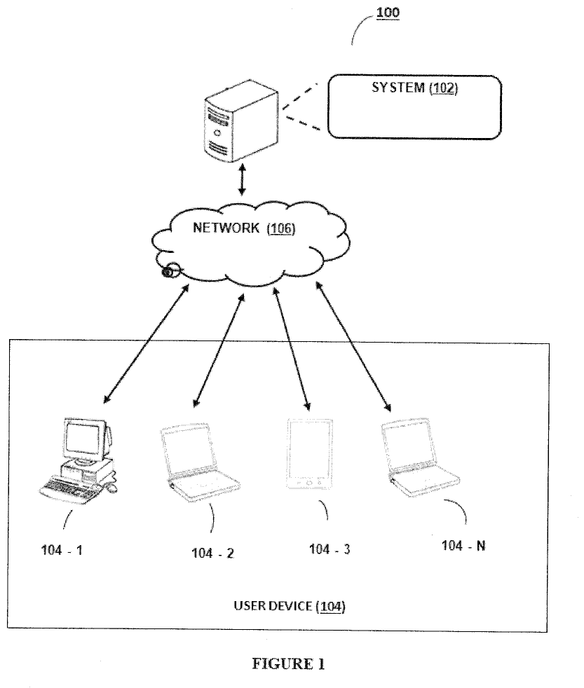

Referring now to FIG. 1, a network implementation 100 of a system 102 to generate recommendations for traffic management is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a cloud network. Further, it will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may receive historical traffic data, associated with a target geographical location, from a set of sources. The historical traffic data may comprise traffic data corresponding to each road segment, from a set of road segments, in the target geographical location. The historical traffic data may correspond to vehicle speeds, traffic accidental incidences, vehicle types, vehicle count, pollution level, weather conditions, pedestrian count and the like. In one example, the historical traffic data may be received from a third-party data provider, government agencies and the like.

Once the historical traffic data is received, the system 102 may analyse the historical traffic data using at least one machine learning algorithm, from a set of machine learning algorithms. Based on the analysis, the system 102 may forecast a traffic intensity, corresponding to each road segment, at pre-defined day parameters. In one embodiment, the system 102 may detect traffic anomaly, associated with each road segment at the pre-defined day parameters, based on analysis of the historical traffic data. The pre-defined day parameters may correspond to day, date, time zone, environmental conditions, events and the like. The set of machine learning algorithms may comprise a Convolutional Neural Network algorithm, a Deep Neural Network algorithm, and a Recurrent Neural Network algorithm.

Upon forecasting the traffic intensity, the system 102 may compare the traffic intensity, corresponding to each road segment, with a predefined threshold upper value. Based on the comparison, the system 102 may identify one or more congested road segments, from the set of road segments. The one or more congested road segments may correspond to road segments with the traffic intensity greater than the predefined threshold upper value.

If the traffic intensity is less than the predefined threshold upper value, then the system 102 may compare the traffic intensity with a predefined threshold lower value. Based on the comparison, the system 102 may identify one or more uncrowded road segments, from the set of road segments. The one or more uncrowded road segments may correspond to road segments with traffic intensity less than or equal to the predefined threshold lower value.

Further, the system 102 may identify a target road segment, corresponding to each congested road segment, using at least one routing algorithm, from a set of routing algorithms. The target road segment may be identified from the one or more uncrowded road segments. The set of routing algorithms may comprise a Dijkstra algorithm, an incremental graph algorithm, a genetic algorithm, and a tabu search algorithm. In one example, the target road segment, corresponding to each congested road segment, may be an alternate road segment for the congested road segment to divert traffic from the congested road segment to the target road segment.

Furthermore, the system 102 may generate one or more recommendations based on the target road segment for traffic management. The one or more recommendations may be associated with the one or more congested road segments and the one or more uncrowded road segments. The one or more recommendations may comprise change in a one-way traffic, a two-way traffic, a signal free U-turns, a speed limit, a lane driving and the like. The one or more recommendations may be further transmitted to the third-party data providers or the government agencies. The third-party data providers or the government agencies may further take actions for traffic management based on the one or more recommendations.

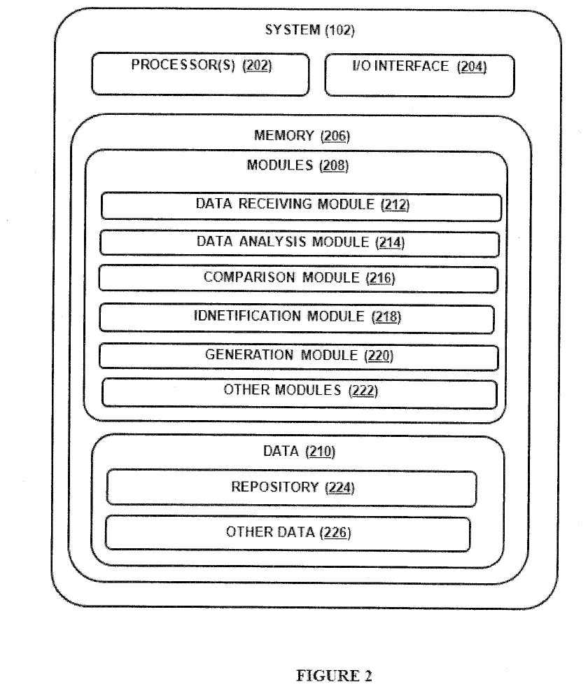

Referring now to FIG. 2, the system 102 to generate recommendations for traffic management is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory, (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include data receiving module 212, data analysis module 214, a comparison module 216, an identification module 218, a generation module 220, and other modules 222. The other modules 222 may include programs or coded instructions that supplement applications and functions of the system 102.

The data 210, amongst other things, serve as a repository for storing data processed, received, and generated by one or more of the modules 208. The data 210 may also include a repository 224, and other data 226. In one embodiment, the other data 2246 may include data generated as a result of the execution of one or more modules in the other modules 222.

In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102.

In one embodiment, the data receiving module 212 may receive historical traffic data, associated with a target geographical location, from a set of sources. The set of sources may comprise camera, LIDAR, radar, laser, sensors, GSM (Global System for Mobile Communication), gas monitors, particle sampler and monitors, speciation monitors, optical and visibility sensors, Doppler radar, satellites, calendars, third-party API's and the like. In one example, the historical traffic data may be received from a third-party data provider or government agencies. The historical traffic data may correspond to traffic data, associated with each road segment, from a set of road segments, in the target geographical location. In one aspect, the historical traffic data, associated with each road segment, may correspond to a particular day, date, time zone and the like. The historical traffic data may comprise vehicles speeds, traffic accidental incidences, vehicle types, vehicle count, pollution level, weather conditions, festival/seasonal effect and pedestrian count. In one embodiment, the data receiving module 212 may pre-process the historical traffic data to generate structured historical traffic data.

In one example, construe area A as the target geographical location of a city. The area A may comprise the set of 10 road segments. In this case, the data receiving module 212 may receive the historical traffic data, associated with each road segment, from the 10 road segments. The historical traffic data may correspond to traffic data, associated with each road segments, for last 3 months for a particular time i.e. 7:30 AM to 10 AM.

Once the historical traffic data is received, the data analysis module 214 may analyse the historical traffic data using at least one machine learning algorithm, from a set of machine learning algorithms. The set of machine learning algorithms comprises a Convolutional Neural Network algorithm, a Deep Neural Network algorithm, and a Recurrent Neural Network algorithm. Based on the analysis of the historical traffic data, the data analysis module 214 may be configured to forecast a traffic intensity, associated with each road segment, at pre-defined day parameters. The pre-defined day parameters may correspond to day, date, time zone, environmental conditions associated with the time zone, events associated with the date and the like. In other words, the data analysis module 214 may determine traffic intensity, associated with each road segment, based on analysis of the historical traffic data for particular day, date, time, weather condition, and event on the day.

In one embodiment, the data analysis module 214 may perform a video analysis or an image analysis of the historical traffic data. In this case, the data analysis module 214 may identity pedestrians, vehicles, accidents on each road segment based on video analysis or the image analysis. Based on the analysis, the data analysis module 214 may forecast at least one of traffic intensity, associated with each road segment, traffic anomaly, associated with each road segment, traffic violations, associated with each road segment, and the like. The traffic intensity may correspond to level of traffic on each road segment.

In one example, the traffic anomaly may correspond to accidental incidences occurred on each road segment in a particular time zone of a day. In another example, the traffic anomaly may correspond to accidental incidences occurred on each road segment, when the level of traffic on the road segment is high. The traffic violations may correspond to violation of the traffic rules by one or more vehicle due to reasons like driving in wrong lane, not following traffic signals and the like. In other words, the data analysis module 214 may analyse the historical traffic data and forecast the traffic intensity, the traffic violations, and the traffic anomaly for a specific time period.

Further, the comparison module 216 may compare the traffic intensity, associated with each road segment, with a predefined threshold upper value. Based on the comparison, the comparison module 216 may identify one or more congested road segments, from the set of road segments. The one or more congested road segments may correspond to road segments with the traffic intensity greater than the predefined threshold upper value. Further, the comparison module 216 may analyse the traffic anomaly and the traffic violations, associated with each congested road segment.

If the traffic intensity is less than the predefined threshold upper value, then the comparison module 216 may compare the traffic intensity, associated with each road segment, with a predefined threshold lower value. Based on the comparison, the comparison module 216 may identify one or more uncrowded road segments, from the set of road segments. The one or more uncrowded road segments may correspond to road segments with traffic intensity less than or equal to the predefined threshold lower value. In one example, the predefined threshold upper value and the predefined threshold lower value may be defined by government agencies earlier. Further, the comparison module 216 may analyse the traffic anomaly and the traffic violations, associated with each uncrowded road segment.

Upon comparison, the identification module 218 may identify a target road segment, corresponding to each congested road segment, using at least one routing algorithm from a set of routing algorithms. The set of routing algorithms may comprise a Dijkstra algorithm, an incremental graph algorithm, a genetic algorithm, and a tabu search algorithm. The target road segment may be identified from the one or more uncrowded road segments. In other words, the target road segment, corresponding to a congested road segment, may be a road segment that can be utilized to divert vehicles from the congested road segment. In one aspect, the identification module 218 may analyse the traffic anomaly and the traffic violations to identify the target road segment.

In one embodiment, the target road segment may be a road segment with optimal route length, less travel time, case of driving, and less pollution level. In other words, the target road segment may be a best route to reduce traffic on the congested route by deviating vehicles to the target road segment. It must be understood that, due to deviation of the vehicles, distance that has to be traveled by the vehicles may increase but this helps to reduce the traffic intensity on the congested road segment.

Once the target road segment is identified, the generation module 220 may be configured to generate one or more recommendations based on the target road segment for traffic management. The one or more recommendations may be associated with the one or more congested road segments and the one or more uncrowded road segments. In one embodiment, the one or more recommendations may correspond to change in one-way traffic, a two-way traffic, signal free U-turns, a speed limit, a lane driving and the like. The one or more recommendations may correspond to one or more ways to manage traffic associated with the one or more congested road segments. The one or more recommendations may ensure less number of turns and intersections on the congested road segment and the target road segment.

In one embodiment, the one or more recommendations may be generated in order to deviate the vehicles from the congested road segment to the target road segment. In one aspect, in order to deviate the vehicle from the congested road segment to the target road segment, the vehicles may need to take U-turn from any signal, in this case the one or more recommendations may be generated for traffic signs.

In one example, if the congested road segment is two-way road, then the one or more recommendations may correspond to changing the congested road segment into one-way road. In another example, if the congested road segment is one-way road, then the one or more recommendations may correspond to changing the congested road segment into two-way road segment. In yet another example, the one or more recommendations may indicate that traffic signs regarding lanes and the speed limits needs to be updated on the one or more congested road segments and the one or more uncrowded road segments.

In one embodiment, the one or more recommendations may be further provided to the third-party data providers or the government agencies. Further, the third-party data providers or the government agencies may take actions based on the one or more recommendations. Thus, the one or more recommendations may help for traffic management.

Exemplary embodiments discussed above may provide certain advantages. Though not required to practice aspects of the disclosure, these advantages may include those provided by the following features.

Some embodiments of the system and the method are configured to generate recommendations based on analysis of historical traffic data.

Some embodiments of the system and the method are configured to identify an optimal route.

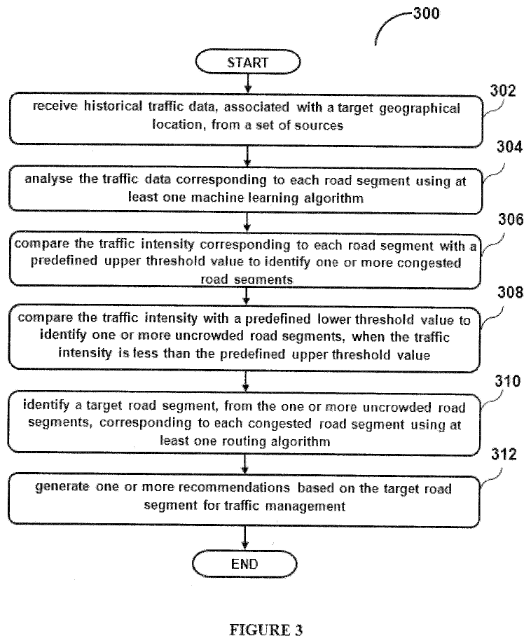

Referring now to FIG. 3, a method 300 to generate recommendations for traffic management, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, historical traffic data, associated with a target geographical location, may be received from a set of sources. In one implementation, the data receiving module 212 may receive the historical traffic data. The historical traffic data may comprise traffic data corresponding to each road segment, from a set of road segments, in the target geographical location.

At block 304, the historical traffic data may be analysed using at least one machine learning algorithm, from a set of machine learning algorithms. In one implementation, the data analysis module 214 may analyse the historical traffic data. Further, a traffic intensity, corresponding to each road segment, may be determined based on the analysis of the historical traffic data.

At block 306, the traffic intensity, corresponding to each road segment, may be compared with a predefined threshold upper value. In one implementation, the comparison module 216 may compare the traffic intensity with the predefined threshold upper value. Based on the comparison, one or more congested road segments, from the set of road segments, may be identified.

At block 308, the traffic intensity may be compared with a predefined threshold lower value, when the traffic intensity is less than the predefined threshold upper value. In one implementation, the comparison module 216 may compare the traffic intensity with the predefined threshold lower value. Based on the comparison, one or more uncrowded road segments, from the set of road segments, may be identified.

At block 310, a target road segment, corresponding to each congested road segment, may be identified using at least one routing algorithm, from a set of routing algorithms. In one implementation, the identification module 218 may identify the target road segment. The target road segment may be identified from the one or more uncrowded road segments.

At block 312, one or more recommendations may be generated based on the target road segment for traffic management. In one implementation, the generation module 220 may generate the one or more recommendations. The one or more recommendations may be associated with the one or more congested road segments and the one or more uncrowded road segments.

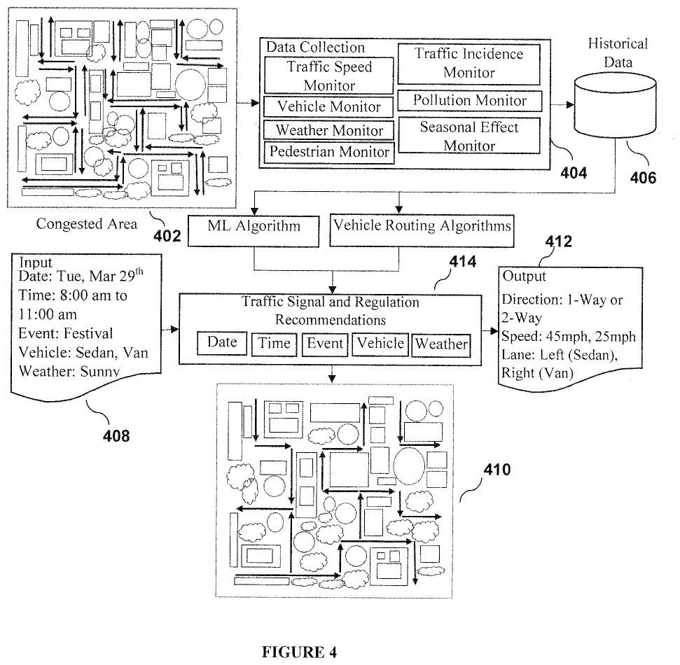

Referring now to FIGS. 4, 5 and 6, an exemplary embodiment of a system for generating recommendation for traffic management, is disclosed in accordance with an embodiment of the present subject matter. In one embodiment, congested area 402 corresponds to the target geographical location in a city. The historical traffic data may be received from a set of sources. The historical traffic data may be associated with each road segment from a set of road segments, in the target geographical location 402. The set of sources correspond to one or more sources from a data collection 404. The set of sources comprises a traffic speed monitor, a traffic incidence monitor, a vehicle monitor, a pollution monitor, a weather monitor, a seasonal effect monitor, and a pedestrian monitor. Once the historical traffic data is received, the historical traffic data may be stored in a historical traffic data repository 406.

Further, the historical traffic data may be analysed using at least one machine learning algorithm corresponding to one of Convolutional Neural Network (CNN), Deep Neural Network (DNN), and Recurrent Neural Network (RNN). Based on the analysis of the historical traffic data, a traffic intensity, associated with each road segment, may be determined. In this case, a traffic signal and regulation recommendations 414 may determine the traffic intensity based on analysis of the historical traffic data. In one example, the historical traffic data may be associated with each road segment, in the target geographical location 402, for a pre-defined day parameters corresponding to input 408. The pre-defined day parameters may correspond to day Tuesday, date March 29, time period 8:00 am to 11:00 am, event festival, and weather sunny.

Furthermore, the traffic intensity may be compared with a predefined upper threshold value. In this case, the traffic signal and regulation recommendations 414 may compare the traffic intensity and the predefined upper threshold value. Based on the comparison, the traffic signal and regulation recommendations 414 may identify one or more congested road segments, from the set of road segments.

If the traffic intensity is less than the predefined upper threshold value, the traffic signal and regulation recommendations 414 may compare the traffic intensity with a predefined lower threshold value. Based on the comparison, one or more uncrowded road segments may be identified.

The traffic signal and regulation recommendations 414 may identify a target segment, from the one or more uncorded road segments, corresponding to each congested road segment. The target road segment may be identified using routing algorithm corresponding to Dijkstra, tabu search, genetic algorithm and incremental algorithm. In this case, the target road segment, corresponding to the one or more congested road segments, may be target segments 410. Further, the traffic signal and regulation recommendations 414 may generate one or more recommendations based on the target road segment for traffic management. The one or more recommendations may correspond to the output 412. The one or more recommendations may comprise changing direction as one-way road, two-way road. The one or more recommendation may comprise speed limit for vehicles. In this case, the recommendation corresponds to speed limit of 45 mph for a particular vehicle and 25 mph for another vehicle. Furthermore, the one or more recommendations may correspond to recommending driving lanes for vehicles i.e. left or right lane.

Referring now to FIG. 5, construe the target geographical location 402 comprising a congested road segment. The congested road segment may be identified based on comparison of the traffic density and the predefined upper threshold value. The congested road segment may comprise parameters such as distance 11 km, intersections 8, turns 12, time to travel the road segment 30 min, speed limit for vehicles 20 kmph, and pollution level PM2.5—181, PM10—93, NO₂—12. In this case, routing algorithm may be used to identify a target road segment to divert traffic from the congested road segment. The one or more recommendations may correspond to diverting the traffic from the congested road segment to the target road segment with distance 12 km, intersections 3, turns 5, time to travel 22 min, speed limit 24 kmph, and the pollution level PM2.5—125, PM10: 80, NO₂: 8.

Referring to FIG. 6, construe the one or more recommendations corresponding to changing two-way road segment into a one-way road segment. The road segments shown in red color may be the two-way road segments. Based on the recommendations, the two-ways road segments may be changed to the one-way road segments. The road segments shown in blue color corresponds to the one-way road segments. The one or more recommendations may be generated to manage traffic associated with the two-way road segments.

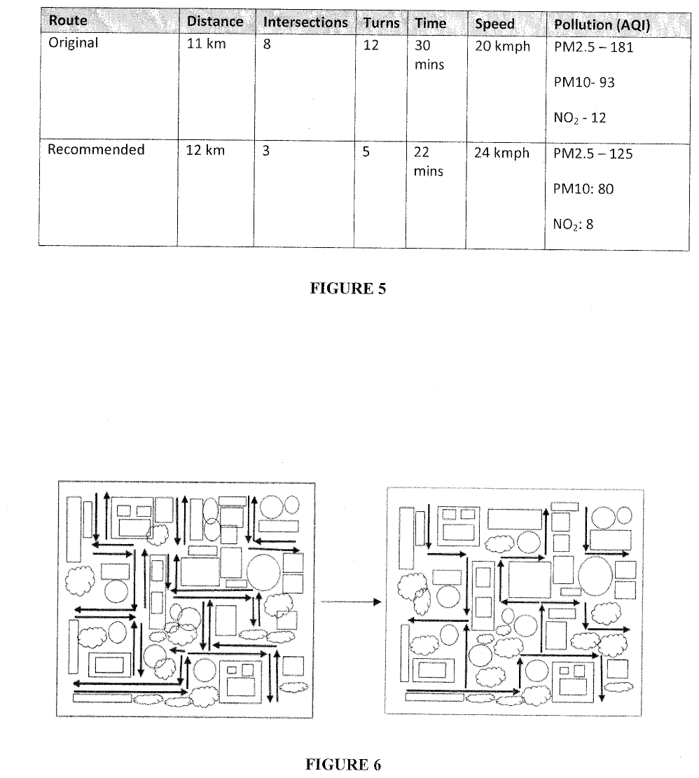

Referring now to FIG. 7, pre-processing of historical traffic data, is disclosed in accordance with an embodiment of the present subject matter. In one embodiment, the historical traffic data, associated with each road segment from a set of road segments, in a target geographical location may be received. The historical traffic data may be received from a set of sources. The historical traffic data may correspond to vehicles speed, traffic incidences, vehicle type, pedestrian count, pollution level, weather condition and seasonal effect. The historical traffic data corresponding to the vehicle speed, the pedestrian count, the traffic incidences, the vehicles types may be received from one or more sources such as camera, Lidar, Radar, Laser, Sensors, GPS (Global Positioning System) enabled mobile, GSM (Global System for Mobile Communication), and third party API. Further, the historical traffic data corresponding to pollution level may be received from the one or more sources such as continuous gas monitors, particle sampler and monitors, optical & visibility sensors, ozonesonders, satellite, Lidar & aircraft, and third party API. Furthermore, the historical traffic data corresponding to weather conditions may be received from the one or more sources such as Doppler radar, satellite data, automated surface observing systems and third party APIs. The historical traffic data corresponding to the seasonal effects may be received from the one or more sources such as calendars and third party APIs. Once the data is received, the historical traffic data may be pre-processed using one or more algorithms to generate structured data. The structured data may be further stored in a historical data repository.

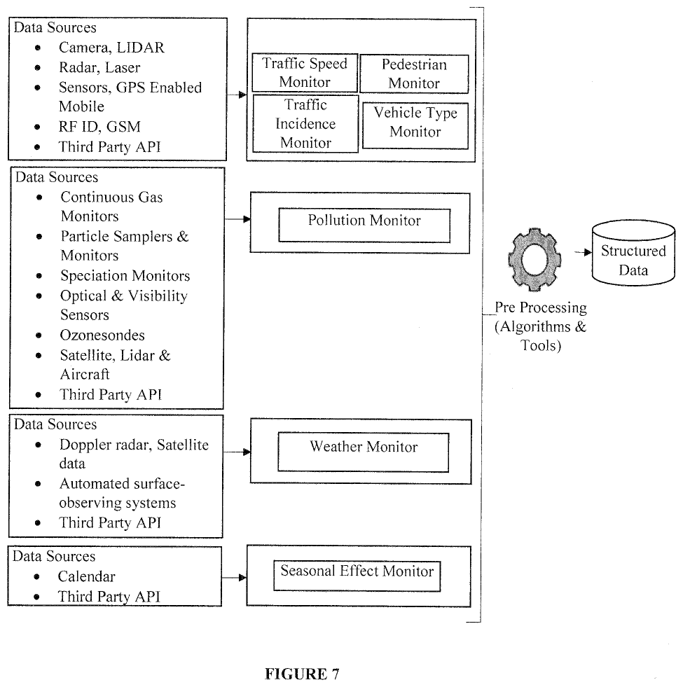

Referring now to FIG. 8, analysis of the historical traffic data using machine learning algorithm, is disclosed in accordance with an embodiment of the present subject matter. In one embodiment, the historical traffic data, associated with the target geographical location, may be analysed using at least one machine learning algorithm from a set of machine leaning algorithms. The set of machine leaning algorithms may comprise a Convolutional Neural Network, a Deep Neural Network, a Recurrent Neural Network and the like.

In one embodiment, a video analysis or an image analysis may be performed on the historical traffic data. Based on the video analysis or the image analysis, number of pedestrians, vehicles, accidents on each road segment may be identified. Based on the analysis, a traffic intensity, associated with each road segment, may be determined. Also, traffic anomaly, associated with each road segment, traffic violations, associated with each road segment, may be determined.

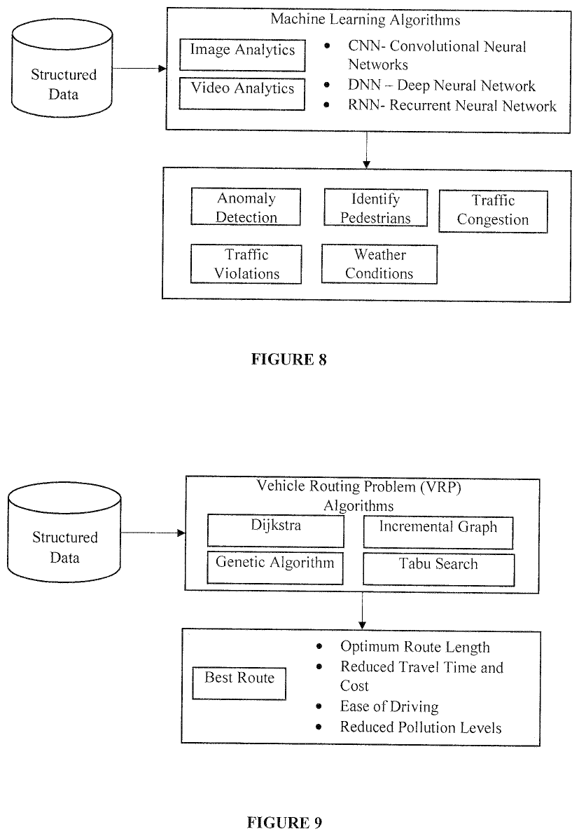

Referring now to FIG. 9, identification of a target road segment using routing algorithm, is disclosed in accordance with an embodiment of the present subject matter. In one embodiment, the traffic intensity may be compared with the predefined upper threshold value. Based on the comparison, one or more congested road segments, from a set of road segments. If the traffic intensity is less than the predefined upper threshold, the traffic intensity may be compared with the predefined lower threshold value. Based on the comparison, one or more uncrowded road segments, from the set of road segments, may be identified. Further, a target road segment, from the one or more uncrowded road segments, may be identified using at least one routing algorithm, from a set of routing algorithms. The set of routing algorithms may comprise Dijkstra algorithm, incremental graph algorithm, genetic algorithm, tabu algorithm and the like. The target road segment may be a road segment where vehicles from the congested road segment are to be diverted. The target road segment may correspond to an optimal road segment with less pollution level, easy driving, reduced travel cost and time.

Although implementations for systems and methods to generate recommendation for traffic management have been described, it is to be understood that the appended claims are not necessarily limited to the specific features or methods described. Rather, the specific features and methods are disclosed as examples of implementations to generate recommendations for traffic management.

We claim:

1. A system to generate recommendations for traffic management, the system comprising:
a memory;
a processor coupled to the memory, wherein the processor is configured to execute programmed instructions stored in the memory to:
receive historical traffic data, associated with a target geographical location, from a set of sources, wherein the historical traffic data comprises traffic data corresponding to each road segment, from a set of road segments, in the target geographical location;
analyze the traffic data corresponding to each road segment using at least one machine learning algorithm, from a set of machine learning algorithms, to forecast a traffic intensity, corresponding to each road segment, at pre-defined day parameters;
compare the traffic intensity corresponding to each road segment with a predefined upper threshold value to identify one or more congested road segments from the set of road segments;
compare the traffic intensity corresponding to each road segment with a predefined lower threshold value to identify one or more uncrowded road segments from the set of road segments, when the traffic intensity is less than the predefined upper threshold value;
identify a target road segment, from the one or more uncrowded road segments, corresponding to each congested road segment using at least one routing algorithm from a set of routing algorithms; and
generate one or more recommendations, corresponding the one or more congested road segments and the one or more uncrowded road segments, based on the target road segment for traffic management.

2. The system as claimed in claim 1, wherein the processor is further configured execute programmed instructions stored in the memory to detect traffic anomaly corresponding to each road segment at the predefined day parameters based on analysis of the traffic data using at least one machine learning algorithm.

3. The system as claimed in claim 1, wherein the historical traffic data corresponds to vehicle speeds, traffic accidental incidences, vehicle types, vehicle count, pollution level, weather conditions, festival/seasonal effect and pedestrian count.

4. The system as claimed in claim 1, wherein the pre-defined day parameters corresponds to date, time zone, environmental conditions, and events.

5. The system as claimed in claim 1, wherein the set of machine learning algorithms comprises a Convolutional Neural Network, a Deep Neural Network and a Recurrent Neural Network.

6. The system as claimed in claim 1, wherein the set of routing algorithms comprises a Dijkstra algorithm, an incremental graph algorithm, a genetic algorithm, and a tabu search algorithm.

7. The system as claimed in claim 1, wherein the one or more recommendations comprises change in a one-way traffic, a two-way traffic, a signal free U-turns, a speed limit, and a lane driving.

8. A method to generate recommendations for traffic management, the method comprises steps of:
receiving, by a processor, historical traffic data, associated with a target geographical location, from a set of sources, wherein the historical traffic data comprises traffic data corresponding to each road segment in the target geographical location;
analysing, by the processor, the traffic data corresponding to each road segment using at least one machine learning algorithm, from a set of machine learning algorithms, to forecast a traffic intensity, corresponding to each road segment, at pre-defined day parameters;
comparing, by the processor, the traffic intensity corresponding to each road segment with a predefined upper threshold value to identify one or more congested road segments from the set of road segments;
comparing, by the processor, the traffic intensity corresponding to each road segment with a predefined lower threshold value to identify one or more uncrowded road segments from the set of road segments, when the traffic intensity is less than the predefined upper threshold value;
identifying, by the processor, a target road segment, from the one or more uncrowded road segments, corresponding to each congested road segment using at least one routing algorithm from a set of routing algorithms; and
generating, by the processor, one or more recommendations, corresponding the one or more congested road segments and the one or more uncrowded road segments, based on the target road segment for traffic management.

9. The method as claimed in claim 8, further comprising detecting traffic anomaly corresponding to each road segment at the predefined day parameters based on analysis of the traffic data using at least one machine learning algorithm.

10. The method as claimed in claim 8, wherein the historical traffic data corresponds to vehicle speeds, traffic accidental incidences, vehicle types, vehicle count, pollution level, weather conditions, festival/seasonal effect and pedestrian count.

11. The method as claimed in claim 8, wherein the pre-defined day parameters corresponds to date, time zone, environmental conditions, and events.

12. The method as claimed in claim 8, wherein the set of machine learning algorithms comprises a Convolutional Neural Network, a Deep Neural Network and a Recurrent Neural Network.

13. The method as claimed in claim 8, wherein the set of routing algorithms comprises a Dijkstra algorithm, an incremental graph algorithm, a genetic algorithm, and a tabu search algorithm.

14. The method as claimed in claim 8, wherein the one or more recommendations comprises change in a one-way traffic, a two-way traffic, a signal free U-turns, a speed limit, and a lane driving.

15. A computer program product having embodied thereon a computer program for providing access to a user based on a multi-dimensional data structure, the computer program product comprising:
a program code for receiving historical traffic data, associated with a target geographical location, from a set of sources, wherein the historical traffic data comprises traffic data corresponding to each road segment in the target geographical location;
a program code for analysing the traffic data corresponding to each road segment using at least one machine learning algorithm, from a set of machine learning algorithms, to forecast a traffic intensity, corresponding to each road segment, at pre-defined day parameters;
a program code for comparing the traffic intensity corresponding to each road segment with a predefined upper threshold value to identify one or more congested road segments from the set of road segments;
a program code for comparing the traffic intensity corresponding to each road segment with a predefined lower threshold value to identify one or more uncrowded road segments from the set of road segments, when the traffic intensity is less than the predefined upper threshold value;
a program code for identifying a target road segment, from the one or more uncrowded road segments, corresponding to each congested road segment using at least one routing algorithm from a set of routing algorithms; and
a program code for generating one or more recommendations, corresponding the one or more congested road segments and the one or more uncrowded road segments, based on the target road segment for traffic management.
